(19) United States
(12) Patent Application Publication
(10) Pub. No.: US 2026/0120980 A1
(43) Pub. Date: Apr. 30, 2026

(54) KEY DEVICE FOR MEMBRANE KEYBOARD

(71) Applicant: SUNREX TECHNOLOGY CORP., Taichung City (TW)

(72) Inventors: Chun-Chieh CHEN, Taichung City (TW); Kyan-Jung LI, Taichung City (TW); Yu-Chia CHI, Taichung City (TW)

(21) Appl. No.: 19/021,655

(22) Filed: Jan. 15, 2025

(30) Foreign Application Priority Data
Oct. 29, 2024 (TW) 113141300

(51) Int. Cl. H01H 13/85; H01H 13/04

(52) U.S. Cl. CPC H01H 13/85; H01H 13/04; H01H 2215/03

(57) ABSTRACT

A key device includes a support plate and a lower casing that cooperatively define a sound amplification space. A resilient plate is disposed within the sound amplification space. An upper cover accommodates an elastic body. A key includes a keycap, an abutment member, and two prongs. One of the prongs abuts against the resilient plate. When the keycap is pressed to move relative to the upper cover, the abutment member compresses the elastic body, and the resilient plate is deformed by the one of the prongs and stores a resilient force. When the keycap is released, the elastic body urges the key to move relative to the upper cover, and the resilient plate is driven by the resilient force to knock against the one of the prongs for producing a click sound.

### CROSS-REFERENCE TO RELATED APPLICATION

This application claims priority to Taiwanese Invention Patent Application No. 113141300, filed on Oct. 29, 2024, the entire disclosure of which is incorporated by reference herein.

### FIELD

The disclosure relates to an input device, and more particularly to a key device for a membrane keyboard.

### BACKGROUND

A keyboard is a common input device or an interface device widely used with desktop computers, laptop computers, and other electronic devices. Based on key strokes and trigger mechanisms in different structural designs, keyboards are sorted into mechanical keyboards and membrane keyboards.

Under each keycap of a mechanical keyboard, there is an individual mechanical switch for triggering a signal. There are many types of mechanical switches. Consumers' preferred type of mechanical switch is one that can provide staged resistance and tactile feedback and produce an audible sound. A membrane keyboard includes a plurality of keycaps, a plurality of rubber dome switches respectively disposed relative to the keycaps, a membrane circuit board, and a bottom board. When one of the keycaps is pressed to drive a respective one of the rubber dome switches, the respective one of the rubber dome switches triggers the membrane circuit board to generate a triggering signal. When the membrane keyboard is used, the keycaps are pressed to knock against the bottom board, thereby producing sounds.

In contrast to a mechanical keyboard, a membrane keyboard in use provides less staged resistance and tactile feedback and produces less audible sounds, though the manufacturing cost of a membrane keyboard may be low.

Many users desire a membrane keyboard that can provide staged resistance and tactile feedback and produce an audible sound as a mechanical keyboard can. However, if the membrane keyboard incorporates the mechanical switches in order to provide the staged resistance and tactile feedback and to produce the audible sound, the key configurations will be significantly altered, the manufacturing cost of the membrane keyboard will increase, and assembly of the membrane keyboard will become more difficult.

### SUMMARY

Therefore, an object of the disclosure is to provide a key device for a membrane keyboard that can provide a tactile feedback and produce a click sound and that can be manufactured at a low cost.

According to the disclosure, a key device includes a lower cover, a support plate, a resilient plate, a membrane circuit board, an elastic body, an upper cover, and a key.

The lower cover includes a base wall and a lower casing that protrudes downwardly from the base wall.

The support plate is disposed over the base wall, and cooperates with the lower casing to define a sound amplification space.

The resilient plate is connected to the lower casing, and is disposed within the sound amplification space.

The membrane circuit board is disposed over the support plate.

The elastic body is disposed over the membrane circuit board.

The upper cover includes an upper wall and a surrounding wall. The surrounding wall extends upwardly from the upper wall, and defines an accommodating space having an upper open end and a lower open end that are opposite to each other. The accommodating space accommodates the elastic body.

The key includes a keycap, an abutment member, and two prongs. The keycap is movably disposed over the upper cover. The abutment member extends downwardly from the keycap into the accommodating space, and abuts against the elastic body. The two prongs extend downwardly from the abutment member through the membrane circuit board and the support plate into the sound amplification space. One of the prongs abuts against the resilient plate.

When the keycap is pressed to move downwardly relative to the upper cover from a normal position to a pressed position, the abutment member compresses the elastic body, and the resilient plate is resiliently deformed by the one of the prongs and stores a resilient force.

When the keycap is released from the pressed position, the elastic body restores and urges the key to move upwardly relative to the upper cover, and the resilient force of the resilient plate is released and drives the resilient plate to knock against the one of the prongs for producing a click sound.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded perspective view illustrating a key device according to an embodiment of the disclosure.

FIG. 2 is an enlarged perspective view of the embodiment illustrating a lower cover and a resilient plate of the key device.

FIG. 3 is a sectional view of the embodiment illustrating a keycap of the key device at a normal position.

FIG. 4 is a fragmentary enlarged sectional view of FIG. 3.

FIG. 5 is a sectional view of the embodiment illustrating the keycap of the key device at a pressed position

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

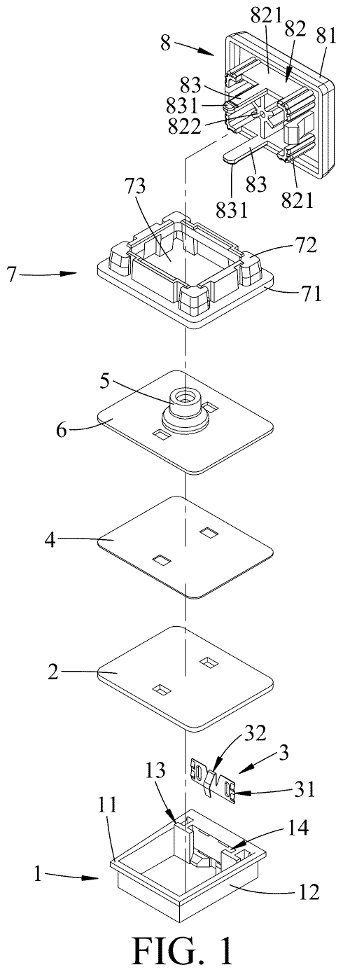

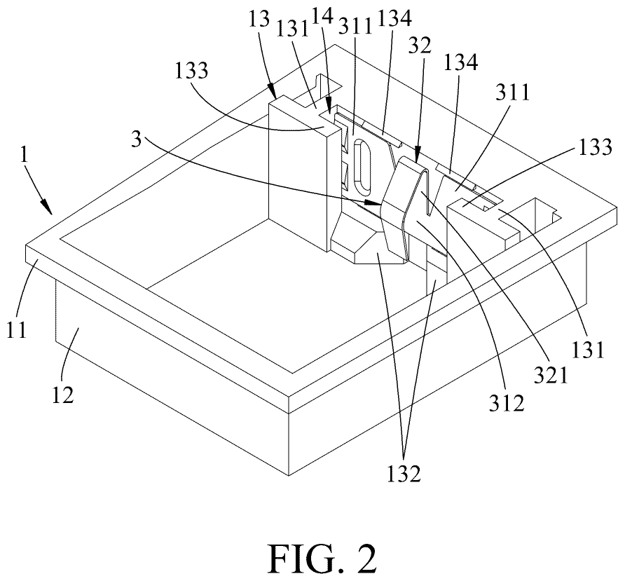

FIGS. 1 and 2 illustrate a key device according to an embodiment of the disclosure for a membrane keyboard (not shown). The key device includes a lower cover 1, a support plate 2, a resilient plate 3, a membrane circuit board 4, an elastic body 5, a rubber sheet 6, an upper cover 7, and a key 8.

The lower cover includes a base wall 11, a lower casing 12 that protrudes downwardly from the base wall 11, and an engagement structure 13 that is integrally connected to an inner surface of the lower casing 12. The engagement structure 13 has two extension walls 131, two bottom walls 132, two blocking walls 133, and two limiting ribs 134. The two extension walls 131 extend from the inner surface of the lower casing 12, and are spaced apart from each other. The two bottom walls 132 are respectively connected to bottom ends of the extension walls 131. The two blocking walls 133 extend respectively from the extension walls 131 toward each other. The two limiting ribs 134 are formed on a top end of the inner surface of the lower casing 12.

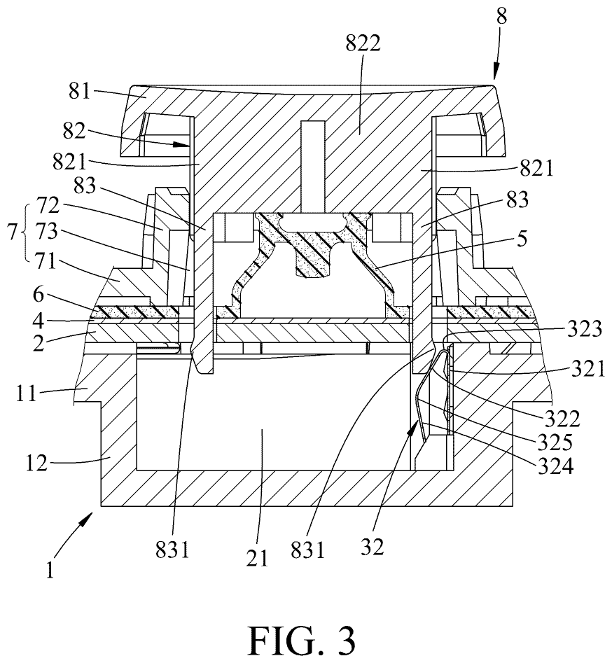

Referring to FIG. 3 in combination with FIG. 1, the support plate 2 is disposed over the base wall 11, and cooperates with the lower casing 12 to define a sound amplification space 21. The inner surface of the lower casing 12, the extension walls 131, the bottom walls 132, and the blocking walls 133 cooperatively define an engagement recess 14 in the sound amplification space 21.

As shown in FIGS. 1 to 3, the resilient plate 3 is received in the engagement recess 14, and is connected to the lower casing 12. The resilient plate 3 has a fixed portion 31 that is disposed in the engagement recess 14 and that is connected to the inner surface of the lower casing 12, and a deformable portion 32 that is connected to the fixed portion 31.

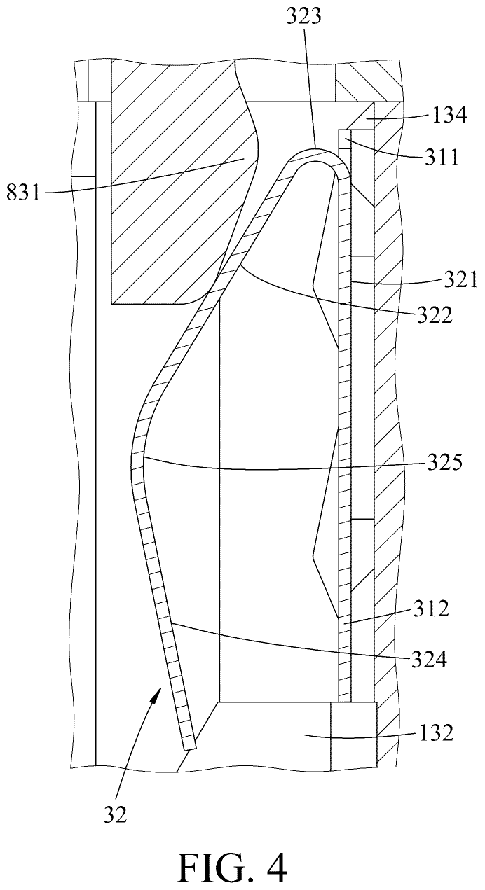

The fixed portion 31 of the resilient plate 3 has two positioning segments 311 and a connection segment 312. Each of the positioning segments 311 is disposed between and abuts against a respective one of the bottom walls 132 and a respective one of the limiting ribs 134 (see FIG. 4). The connection segment 312 interconnects the positioning segments 311. The limiting ribs 134 respectively abut against top ends of the positioning segments 311 of the fixed portion 31 of the resilient plate 3, so that the resilient plate 3 is prevented by the limiting ribs 134 from moving upwardly relative to the engagement recess 14.

The deformable portion 32 of the resilient plate 3 has an extension segment 321, a first bent segment 323, a first contact segment 322, a second bent segment 325, and a second contact segment 324. The extension segment 321 is connected to the connection segment 312 of the fixed portion 31 of the resilient plate 3, extends upwardly toward the support plate 2, and is parallel to the positioning segments 311 of the fixed portion 31 of the resilient plate 3. The first bent segment 323 extends from a top end of the extension segment 321, and has an end portion that is distal from the extension segment 321 and that is bent downwardly. The first contact segment 322 extends downwardly from the end portion of the first bent segment 323, and is tilted away from the extension segment 321. The second bent segment 325 extends downwardly from a bottom end of the first contact segment 322, and has an end portion that is distal from the first contact segment 322 and that is bent toward the extension segment 321. The second contact segment 324 extends downwardly from the end portion of the second bent segment 325 and is tilted toward the extension segment 321.

The membrane circuit board 4 is disposed over the support plate 2.

As shown in FIG. 3, the elastic body 5 is disposed over the membrane circuit board 4 and under the key 8 (the key 8 will be described in further detail below). The elastic body 5 is driven by the key 8 to trigger the membrane circuit board 4 so as to generate a trigger signal.

The rubber sheet 6 is disposed over the membrane circuit board 4, and is integrally connected to the elastic body 5.

As shown in FIGS. 1 and 3, the upper cover 7 includes an upper wall 71 and a surrounding wall 72. The surrounding wall 72 extends upwardly from the upper wall 71, and defines an accommodating space 73 having an upper open end and a lower open end that are opposite to each other. The accommodating space 73 accommodates a portion of the key 8 and the elastic body 5.

As shown in FIGS. 1 and 3, the key 8 includes a keycap 81, an abutment member 82, and two prongs 83. The keycap 81 is movably disposed over the upper cover 7. The abutment member 82 extends downwardly from the keycap 81 into the accommodating space 73, and abuts against the elastic body 5. The abutment member 82 has two lateral walls 821 and an abutment wall 822. The two lateral walls 821 are connected to the keycap 81. The abutment wall 822 interconnects the lateral walls 821 and abuts against the elastic body 5. The two prongs 83 respectively extend downwardly from the two lateral walls 821 through the membrane circuit board 4 and the support plate 2 into the sound amplification space 21. One of the prongs 83 abuts against the deformable portion 32 of the resilient plate 3. Each of the prongs 83 has a push portion 831 extending outwardly therefrom in a direction opposite to the push portion 831 of the other one of the prongs 83.

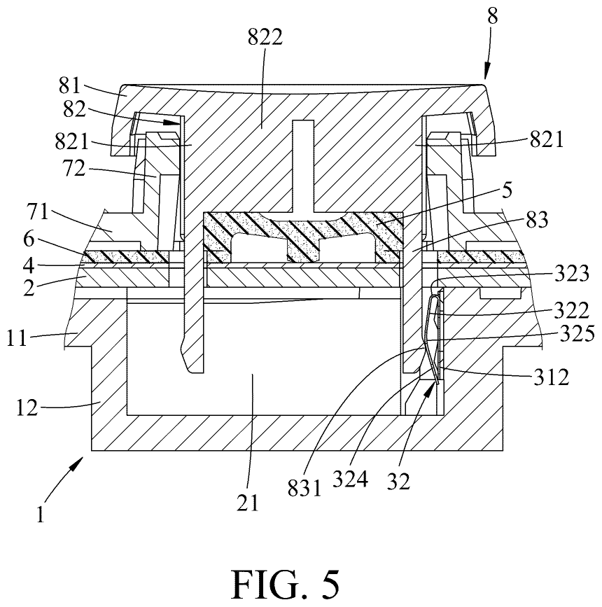

As shown in FIGS. 3 and 5, the keycap 81 is movable relative to the upper cover 7 between a normal position (as shown in FIG. 3) and a pressed position (as shown in FIG. 5).

As shown in FIG. 3, when the keycap 81 is at the normal position, the abutment wall 822 of the abutment member 82 is in contact with the elastic body 5, the keycap 81 is disposed away from the upper wall 71, and the push portion 831 of the one of the prongs 83 abuts against the first contact segment 322 of the resilient plate 3.

As shown in FIG. 5, when the keycap 81 is pressed to move downwardly relative to the upper cover 7 from the normal position to the pressed position, the abutment wall 822 of the abutment member 82 compresses the elastic body 5 such that the elastic body 5 triggers the membrane circuit board 4 to generate a trigger signal, the keycap 81 is moved close to the upper wall 71, and the push portion 831 of the one of the prongs 83 pushes the second contact segment 324 of the resilient plate 3 such that the deformable portion 32 of the resilient plate 3 is resiliently deformed by the one of the prongs 83 and stores a resilient force.

Specifically, when the keycap 81 is pressed to move downwardly relative to the upper cover 7 from the normal position, the first contact segment 322 is pushed by the push portion 831 of the one of the prongs 83 toward the extension segment 321, and the first bent segment 323 is resiliently deformed. When the keycap 81 is moved to the pressed position, the push portion 831 of the one of the prongs 83 pushes the second contact segment 324 toward the connection segment 312 of the resilient plate 3 such that the second bent segment 325 is resiliently deformed. As a result, the deformable portion 32 of the resilient plate 3 stores the resilient force when the keycap 81 is moved to the pressed position.

When a user presses the keycap 81 to move downwardly relative to the upper cover 7 from the normal position to the pressed position, because the deformable portion 32 of the resilient plate 3 is deformed in two stages by the deformation of the first bent segment 323 and the deformation of the second bent segment 325, the user may experience two-stage resistance and tactile feedback provided by the resilient plate 3 in response to pressing the keycap 81.

When the keycap 81 is released from the pressed position, the elastic body 5 restores and urges the key 8 to move upwardly relative to the upper cover 7, and the resilient force of the deformable portion 32 of the resilient plate 3 is released and drives the first contact segment 322 of the deformable portion 32 to knock against and to be momentarily detached from the push portion 831 of the one of the prongs 83, thereby producing a click sound.

Because the resilient plate 3 is received in the engagement recess 14 in the sound amplification space 21, the click sound resulting from the first contact segment 322 knocking against the push portion 831 of the one of the prongs 83 is amplified in the sound amplification space 21 so as to be more audible.

In summary, the key device of the disclosure in use provides two-stage resistance and tactile feedback, and produces the click sound to be amplified in the sound amplification space 21 so as to be more audible. Furthermore, the overall structure of the key device of the disclosure is relatively simple, thereby reducing manufacturing cost.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A key device comprising:
a lower cover including
a base wall, and
a lower casing that protrudes downwardly from said base wall;
a support plate disposed over said base wall, and cooperating with said lower casing to define a sound amplification space;
a resilient plate connected to said lower casing, and disposed within said sound amplification space;
a membrane circuit board disposed over said support plate;
an elastic body disposed over said membrane circuit board;
an upper cover including
an upper wall, and
a surrounding wall that extends upwardly from said upper wall, and that defines an accommodating space having an upper open end and a lower open end that are opposite to each other, said accommodating space accommodating said elastic body; and
a key including
a keycap that is movably disposed over said upper cover,
an abutment member that extends downwardly from said keycap into said accommodating space, and that abuts against said elastic body, and
two prongs that extend downwardly from said abutment member through said membrane circuit board and said support plate into said sound amplification space, one of said prongs abutting against said resilient plate;
wherein, when said keycap is pressed to move downwardly relative to said upper cover from a normal position to a pressed position, said abutment member compresses said elastic body, and said resilient plate is resiliently deformed by said one of said prongs and stores a resilient force; and
wherein, when said keycap is released from the pressed position, said elastic body restores and urges said key to move upwardly relative to said upper cover, and the resilient force of said resilient plate is released and drives said resilient plate to knock against said one of said prongs for producing a click sound.

2. The key device as claimed in claim 1, wherein:
said resilient plate has
a fixed portion disposed in said lower casing and connected to an inner surface of said lower casing, and
a deformable portion connected to said fixed portion and abutting against said one of said prongs;
when said keycap is pressed to move downwardly relative to said upper cover from the normal position to the pressed position, said deformable portion of said resilient plate is resiliently deformed by said one of said prongs and stores the resilient force; and
when said keycap is released from the pressed position, said elastic body restores and urges said key to move upwardly relative to said upper cover, and the resilient force is released and drives said deformable portion to knock against said one of said prongs for producing the click sound.

3. The key device as claimed in claim 2, wherein;
said deformable portion of said resilient plate has
an extension segment connected to said fixed portion and extending upwardly toward said support plate,
a first bent segment extending from a top end of said extension segment, and having an end portion that is distal from said extension segment and that is bent downwardly,
a first contact segment extending downwardly from said end portion of said first bent segment, and tilted away from said extension segment,
a second bent segment extending downwardly from a bottom end of said first contact segment, and having an end portion that is distal from said first contact segment and that is bent toward said extension segment, and
a second contact segment extending downwardly from said end portion of said second bent segment and tilted toward said extension segment;
when said keycap is pressed to move downwardly relative to said upper cover from the normal position, said first contact segment is pushed by said one of said prongs, and said first bent segment is resiliently deformed;
when said keycap is moved to the pressed position, said one of said prongs pushes said second contact segment such that said second bent segment is resiliently deformed; and
when said keycap is released, said elastic body restores and urges said key to move upwardly relative to said upper cover, and the resilient force is released and drives said first contact segment to knock against said one of said prongs, thereby producing the click sound.

4. The key device as claimed in claim 2, wherein:
said lower cover further includes an engagement structure integrally connected to said inner surface of said lower casing;
said engagement structure has
two extension walls that extend from said inner surface of said lower casing and that are spaced apart from each other,
two bottom walls that are respectively connected to bottom ends of said extension walls,
two blocking walls that extend respectively from said extension walls toward each other, and
two limiting ribs that are formed on a top end of said inner surface of said lower casing;
said inner surface of said lower casing, said extension walls, said bottom walls, and said blocking walls cooperatively define an engagement recess in said sound amplification space;
said resilient plate is received in said engagement recess;
said fixed portion of said resilient plate has
two positioning segments, each of said positioning segments being disposed between and abutting against a respective one of said bottom walls and a respective one of said limiting ribs, and
a connection segment interconnecting said positioning segments; and
said deformable portion of said resilient plate is connected to said connection segment.

5. The key device as claimed in claim 1, further comprising a rubber sheet disposed over said membrane circuit board, and integrally connected to said elastic body.

6. The key device as claimed in claim 1, wherein:
said abutment member of said key has
two lateral walls that are connected to said keycap, and
an abutment wall that interconnects said lateral walls and that abuts against said elastic body; and
said prongs of said key respectively extend downwardly from said two lateral walls.
